(19) United States
(12) Patent Application Publication
(10) Pub. No.: US 2003/0142400 A1
(43) Pub. Date: Jul. 31, 2003

(54) Patterned wire grid polarizer and method of use

(76) Inventors: Douglas P. Hansen, Spanish Fork, UT (US); Raymond Perkins, Orem, UT (US); Jim Thorne, Provo, UT (US); Eric Gardner, Provo, UT (US)

Correspondence Address: THORPE NORTH WESTERN, 8180 SOUTH 700 EAST, SUITE 200, P.O. BOX 1219, SANDY, UT, 84070, US

(21) Appl. No.: 10/352,693

(22) Filed: Jan. 27, 2003

Related U.S. Application Data
(63) Continuation of application No. 09/819,565, filed on Mar. 27, 2001, now abandoned.

(51) Int. Cl. G02B 5/30; G02B 27/28

(52) U.S. Cl. 359/486; 359/485; 359/489

(57) ABSTRACT

A visible light polarizer device includes elements having a different angular orientation with respect to other elements. The elements are sized to interact with visible light to 1) transmit visible light of one polarization orientation, and 2) reflect visible light of another polarization orientation. The device can include 1) primary elements which are substantially parallel with one another, and 2) secondary elements having at least a portion disposed at a different angle orientation with respect to the primary elements. The elements can be configured to transmit visible light of the same first polarization orientation, and reflect visible light of the same second polarization orientation, although they have different angular orientations. Alternatively, the elements can transmit visible light of different polarization orientations.

### BACKGROUND OF THE INVENTION

1. The Field of the Invention

The present invention relates generally to wire grid polarizers operable in the visible spectrum. More particularly, the present invention relates to a patterned wire grid polarizer and method of use.

2. The Background Art

Conventional polarizers typically allow light of a single orientation of linear polarization to pass through them and this orientation is the same regardless of the location of the point of incidence of the light on the polarizer (e.g., at the center of the polarizer surface or near an edge). However, in some applications, it is desirable to have a polarizer which passes light with different polarization orientations at different points on the surface of the optic. Such applications can include three-dimensional displays, data storage, imaging, industrial inspection of manufactured items, polarimeters, etc.

For example, electromagnetic radiation reflected from a dielectric material is partially polarized. A given reflection will appear dim if viewed through a polarizer that blocks the reflected polarization. However, it will appear intense if the polarizer is rotated 90° to pass the reflected polarization. Use has been made of this effect in infrared imaging. A ccd detector with many pixels can be used to turn the infrared light into an electrical signal that could form an image on a monitor. For example, a polarizer with one orientation can be placed over a selected set of pixels, and another polarizer orientation can be placed over another set. Multiple sets with different selected angles produce multiple infrared images of the same subject. Variation in the polarization of infrared light reflected from the object will result in variations in the intensity reaching each of the variably polarized pixels viewing a given spot on the subject. Using these multiple images, angles of parts of the subject relative to the source of infrared illumination can be determined. In addition, if contrast between adjacent objects is low in one polarized image, it is likely to be high in one of the others. What is more, reflections from metal surfaces are different in character from reflections from dielectrics, enabling metal surfaces to be distinguished form non-metals. These characteristics are of great value in interpreting the true shape and nature of the object being viewed by the ccd camera. An especially dramatic example is the spots of glare coming from the waves on a lake or ocean. For each polarization orientation, the spots indicate all of the positions where the water has a specific inclination with respect to the sun and the point of view.

With respect to industrial inspection of manufactured items, light reflected from items as they pass on a conveyor belt can be detected and used to verify the presence of the item. Certain characteristics of the item can also be measured. Normal light severely hinders this process, so the illumination is polarized and the detector responds only to this polarization.

With respect to stress analysis, the stress that is present in an object can change the polarization of reflected light. Observation of the spatial distribution of polarization provides important information about stress and potential failure of the part.

In data transmission applications, electro-optical switching is a limiting technology. It has been suggested that optical switching could be an effective solution to this problem. An important technology in this area is based on liquid crystals which necessitates the use of polarizers.

In addition, when certain optical elements are exposed to plane polarized light, they cause changes in polarization. Short of complete depolarization, they can rotate the plane of polarization, induce some ellipticity in to the beam, or both. In any case, the resulting beam cannot be effectively extinguished by another linear polarizer which may be required in the optical train (e.g. to generate image contrast in a liquid crystal projection display) One solution is to put a “clean up” polarizer behind the element to reject light of the wrong polarization. Unfortunately, this dims portions of the transmitted light beam. The reduction of intensity, and especially the inhomogeneity of intensity across the beam is objectionable in many applications, and especially in imaging systems.

As an example, consider designing such a polarizer to be placed immediately ahead of a spherical lens that is not dichromic or birefringent. Such a lens rotates polarized light by the following mechanism. The ray along the axis of the lens is undeviated in its path, and completely maintains its polarization. Other rays will have their path changed by the action of the lens, causing a rotation of some degree in the polarization orientation of this ray. As a result, the light exiting the lens will have some rays which have maintained their polarization orientation, and other rays with rotated polarization orientations. It would be desirable to correct these polarization aberrations.

These are but a few examples of many which illustrate the broad usefulness of polarizers, especially in the infrared and the visible spectrum, if they can be suited for particular requirements. For example, it is desirable to make micro-polarizers, or polarizers with areas less than about 10 μm². Such polarizers would provide good spatial resolution, but they must be very thin to avoid parallax or adjacent pixel crosstalk from incident skew rays. Unfortunately, it is difficult and time consuming to make a polarizer of a practical size unless the polarizer has only a few large areas.

There are several types of polarizers:

Birefringent crystal prism polarizers are typically as long as they are wide (approximately cubic). They are made of polished, carefully oriented crystal prisms. As a result, they are expensive, and will polarize light only if it has very low divergence or convergence.

The MacNielle cube polarizer is not made of birefringent materials, but it is similar to crystal polarizers in many respects. For both of these, thickness, low acceptance angle and cost prohibit their effective use.

Thinner polarizers can be made of oriented, treated polymer sheets. Although they transmit most of the light of one polarization, they typically absorb virtually all of the light of the orthogonal polarization. This can lead to severe heating in intense light, and the polymers typically degrade at temperatures less than 200 C. Because the absorbing particles are dispersed in the polymer, a certain thickness (approximately 0.05 mm) is required for adequate absorption of the unwanted polarization. In addition, the polymer material is not very stable in environments where temperature and humidity change frequently.

According to U.S. Pat. No. 5,122,907, a more heat-resistant polarizer can be made by orienting prolate metal spheroids embedded in glass provided the spheroids have dimensions that are small compared to the light to be polarized. Unfortunately, such polarizers are not easily produced.

Another type of polymer based polarizer contains no absorbers, but separates the two polarizations with tilted regions of contrasting refractive indexes. An example is described in U.S. Pat. No. 5,422,765, where the light enters from the open side of the V-shaped film, is reflected from one side to the other, and then out. For this retro-reflecting polarizer to work, both sides of the “V” must be present. They are of moderate thickness, do not resist high temperatures, and have limited angular aperture. Again, such polarizers are not easily produced.

A heat-resistant polarizer can be made of inorganic materials of differing refractive index, according to U.S. Pat. No. 5,305,143. Such polarizers can be thin (about 0.1-10.0 μm) because they are inhomogeneous films deposited at an angle on a substrate which may be thin. Unfortunately, there is considerable randomness to the placement of the transparent oxide columns that are deposited to provide the anisotropic structure for the polarizer. The randomness limits performance, so transmission is only about 40%, and the polarization is only about only 70%. This optical performance is inadequate for most applications.

Another evaporated thin film polarizer also is inefficient because of randomness. This type of polarizer is described in U.S. Pat. No. 5,245,471, and is made by oblique evaporation of two materials, at least one of which is birefringent.

Many of the above polarizers either absorb the orthogonal polarization, or reflect it in directions where it is difficult to use.

The pixels of an infrared ccd detector have been covered with wire grids that were made by standard microlithography. Each area is then a grating that efficiently reflects infrared light whose electric vector is parallel to the wires, and transmits the perpendicular polarization. The polarizer in this instance was made by standard semiconductor techniques, that is, using a mask with opaque and transparent areas whose pattern is transferred with light to photoresist that can be developed into the desired mosaic pattern of lines and spaces. The minimum feature size when this method is used is too large to make a sub-wavelength grating for visible light, but it functions well for longer wavelengths such as infrared light.

By comparing the properties of the various known polarizers discussed above, it appears that the wire grid polarizer holds the most promise if it can be made to operate in the visible portion of the spectrum, if it is sufficiently thin, and if its optical properties can be optimized to fit the application. These criteria have not been met for micropolarizer arrays in the current state of the art, in spite of numerous attempts. An example is U.S. Pat. No. 4,514,479, but it does not work in the visible portion of the spectrum.

### SUMMARY OF THE INVENTION

It has been recognized that it would be advantageous to develop a polarizer device capable of polarizing visible light. In addition, it has been recognized that it would be advantageous to develop such a polarizer device capable of treating or affecting a light beam such that the resulting transmitted and/or reflected beams have a controlled or patterned polarization orientation therethrough, with the control or pattern depending on the application. In addition, it has been recognized that it would be advantageous to develop such a polarizer device which treats or affects different portions of the light beam differently, such that the resulting transmitted and/or reflected beams have portions with different polarization orientations, which can be used to compensate for other optical elements, or for other applications.

The invention provides a visible light polarizer device with some elements advantageously having a different angular orientation with respect to other elements. The device includes a plurality of elongated elements sized to interact with visible light to 1) substantially transmit visible light of one polarization orientation, and 2) substantially reflect visible light of another polarization orientation. The device can include 1) primary elements which are substantially parallel with one another, and 2) secondary elements having at least a portion disposed at a different angle of orientation with respect to the primary elements.

Both the primary and secondary elements advantageously can be configured to substantially transmit the same first polarization orientation of visible light, although they have different angular orientations. Similarly, both the primary and secondary elements can substantially reflect the same second polarization orientation of visible light, although they have different angular orientations. Alternatively, the primary and secondary elements can substantially transmit different polarization orientations of visible light.

The plurality of elements can include four quadrants. The quadrants can be defined by a longitudinal axis parallel with and dividing at least some of the elements, and a lateral axis perpendicular to and intersecting the longitudinal axis. The quadrants have distal corners opposite an intersection of the axes. At least some of the elements located in the distal corners of the quadrants advantageously can have at least a portion disposed at a different angular orientation with respect to the other elements. The portion can extend inwardly towards the longitudinal axis, or outwardly away from the longitudinal axis.

In accordance with another aspect of the present invention, at least a portion of at least some of the elements can be arcuate. The arcuate elements can have a curvature within a layer defined by the elements. Some of the elements can be concave, or curved outwardly away the longitudinal axis, or they can be convex, or curved inwardly towards the longitudinal axis.

In accordance with another aspect of the present invention, the plurality of elements can include a plurality of adjacent groups of elements, with the elements within a group each having a similar angular orientation. The elements of at least one group advantageously have a different angular orientation with respect to elements of at least one other group.

The groups can be configured to transmit visible light of different polarization orientations. Alternatively, the groups can be configured to transmit visible light of substantially the same polarization orientation.

In accordance with another aspect of the present embodiment, the groups can have a polygon shape with more than three or four sides.

In accordance with another aspect of the present invention, the plurality of groups can include at least one open zone without any elements.

In accordance with another aspect of the present invention, the elements can be disposed on a first surface of a transparent substrate.

In accordance with another aspect of the present invention, the elements can form acute angles with respect to one another and have widening gaps therebetween. Secondary elements can be disposed in the widening gaps between the primary elements.

In accordance with another aspect of the present invention, a visible light polarizer device advantageously has some elements or zones with a different configuration with respect to other elements or zones. For example, some elements can be wider and have narrow gaps therebetween which can result in a lower transmission and higher contrast. Alternatively, some elements can be narrower and have wider caps therebetween which can result in a higher transmission and a lower contrast. Thus, some zones, or groups or elements, can have wider or narrower elements than other zones or groups, so that such zones or groups have different transmission and contrast characteristics. In either case, the wider or narrower elements can have the same period.

Such a polarizer device can be used to pre-treat a visible beam of light to compensate for an undesired optical effect applied by an optical element. A method for using such a polarizer device includes providing a plane polarized beam of light. The beam of light is passed through the optical element, which is disposed in the beam of light. The optical element can be capable of undesirably modifying the polarization state of at least a portion of the beam of light. At least a portion of the beam of light can be passed through the polarizer device, which can be disposed in the beam of light, prior to exposure to the optical element, to process at least a portion of the beam of light prior to exposure to the optical element, to compensate for the undesirable modification by the optical element.

The optical element might be capable of undesirably rotating the polarization orientation of at least a portion of the beam of light. The polarizer can have a plurality of groups of elongated elements, with the elements of one group having a different orientation with respect to elements of another group, to transmit and/or reflect a different polarization orientation of at least a portion of the beam of light prior to exposure to the optical element.

Alternatively, at least a portion of the beam of light can be passed through the polarizer device after exposure to the optical element to compensate for any undesired optical effect.

The optical element might be capable of undesirably inducing an elliptical polarization into at least a portion of the beam of light. The polarizer can have patterned elements, combined with a waveplate, to induce an opposite elliptical polarization into at least a portion of the beam of light prior to, or after, exposure to the optical element.

Additional features and advantages of the invention will be set forth in the detailed description which follows, taken in conjunction with the accompanying drawing, which together illustrate by way of example, the features of the invention.

### BRIEF DESCRIPTION OF THE DRAWINGS

FIG. 1 is a front view of a polarizer device in accordance with the present invention;

FIG. 2 is a front view of another polarizer device in accordance with the present invention;

FIG. 3a is a front view of another polarizer device in accordance with the present invention;

FIG. 3b is a front view of another polarizer device in accordance with the present invention;

FIG. 4 is a front view of another polarizer device in accordance with the present invention;

FIG. 5a is a schematic view of a prior art polarizer device;

FIG. 5b is a schematic view of the polarizer device of FIG. 1;

FIG. 6a is a schematic view of a prior art optical system;

FIG. 6b is a schematic view of an optical system with the polarizer device of FIG. 2;

FIG. 7 is a front view of another polarizer device in accordance with the present invention;

FIG. 8a is a front view of another polarizer device in accordance with the present invention;

FIG. 8b is a front view of another polarizer device in accordance with the present invention;

FIG. 9a is a perspective view of a single polarized pixel of a photodetector is shown in accordance with the present invention;

FIG. 9b is an exploded view of the polarized pixel of the photodetector of FIG. 9a;

FIG. 9c is a perspective view of an array of pixels of a phototdetector in accordance with the present invention;

FIG. 10 is a front view of another polarizer device in accordance with the present invention; and

FIG. 11 is an end view of another polarizer device in accordance with the present invention.

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

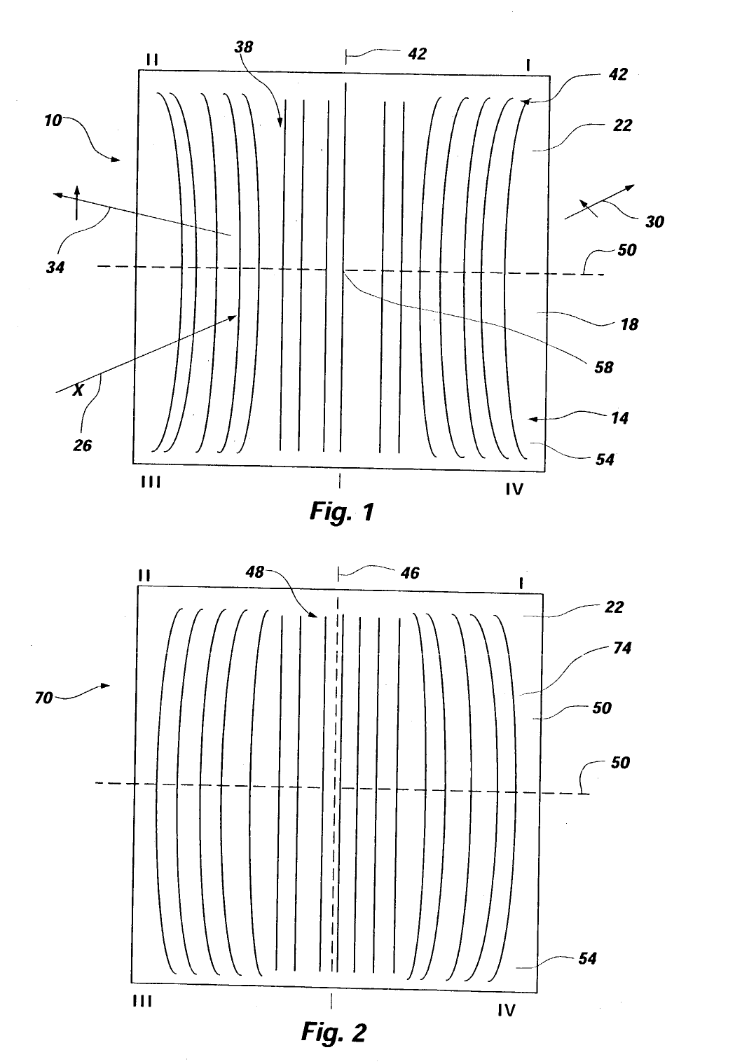

As illustrated in FIGS. 1-4, various visible light polarizer devices in accordance with the present invention are shown for generally separating two orthogonal polarizations of an incident, visible light beam in a controlled or desired manner. The polarizer devices generally transmit one polarization orientation of the visible. light beam, and generally reflect the other polarization orientation. Advantageously, the polarizer devices are configured to treat or affect the incident light beam differently, in order to achieve a transmitted or reflected light beam with desired characteristics or properties. For example, the polarizer devices advantageously can be configured to both 1) produce a light beam with a more uniform polarization orientation across or throughout the light beam, or 2) produce a light beam with distinct, deliberate differences in polarization orientation across the light beam. As discussed above, several fields can benefit from such polarizing devices, including for example, three-dimensional displays, data storage, imaging, part inspection, stress analysis, data transmission, etc.

Referring to FIG. 1, a polarizer device or wire grid polarizer, indicated generally at 10, in accordance with the present invention is shown. The polarizer device 10 includes a plurality of elongated elements 14, which can be associated with a transparent substrate 18, such as by being disposed on a first surface 22 of the substrate 18. The elements 14 advantageously are sized to interact with visible light to 1) substantially transmit visible light of one polarization orientation, and 2) substantially reflect visible light of another polarization orientation.

Thus, the polarizer device 10 can be disposed in a visible light beam, represented by arrow 26, which can be un-polarized, represented by the symbol X. It is of course understood that the visible light beam may be polarized. It will be appreciated that the light beam can be collimated, or can have some convergence or divergence. Although the light beam is represented as a single ray, it will be appreciated that the light beam may be comprised of numerous different rays. The light beam preferably has a wavelength within the visible spectrum, or a wavelength of approximately 400 to 700 nm (nanometers), or 0.4 to 0.7 μm (micrometers or microns).

As stated above, the elements 14 are sized to interact with visible light. Thus, the elements 14 are relatively long and thin. The dimensions are determined by the wavelength used. The following dimensions are believed to be preferable for full spectrum visible light. The elements preferably have a length larger than the wavelength of visible light, or greater than 700 nm (0.7 μm). The length, however, preferably is much longer. In addition, the elements preferably have a center-to-center spacing, pitch or period less than the wavelength of visible light, or less than 400 nm (0.4 μm). More preferably, the elements have a pitch or period less than half the wavelength of visible light, or less than 200 nm (0.2 μm). Furthermore, the elements preferably have a width in the range of 10 to 90% of the pitch or period.

As stated above, the elements 14 interact with the visible light beam 26 to generally 1) transmit a transmitted beam, represented by arrow 30, and 2) reflect a reflected beam, represented by arrow 34. The elements generally transmit light with a first polarization orientation locally orthogonal or transverse to the elements, represented by the symbol [symbol] , and reflect light with a second polarization orientation parallel to the elements, represented by the symbol ↑. It will be appreciated that the polarizer device will separate the polarization orientations of the light beam 26 with a certain degree of efficiency, or some of both polarization orientations may be transmitted and/or reflected.

As stated above, the polarizer devices can be configured to either 1) more uniformly treat or affect the light beam 26, resulting in a more uniform polarization orientation throughout the transmitted and reflected beams 30 and 34, or 2) treat or affect different portions of the light beam 26 differently, resulting in different polarization orientations at different portions of the transmitted and reflected beams 30 and 34, depending on the desired use, or light requirements. Therefore, at least some of the elements, or a portion thereof, advantageously have a different angular orientation with respect to other elements.

The elements 14 can include primary and secondary elements 38 and 42. The primary elements 38 can be relatively straight and parallel with one another, while the secondary elements 42, or a portion thereof, can have a different angular orientation with respect to the primary elements 38.

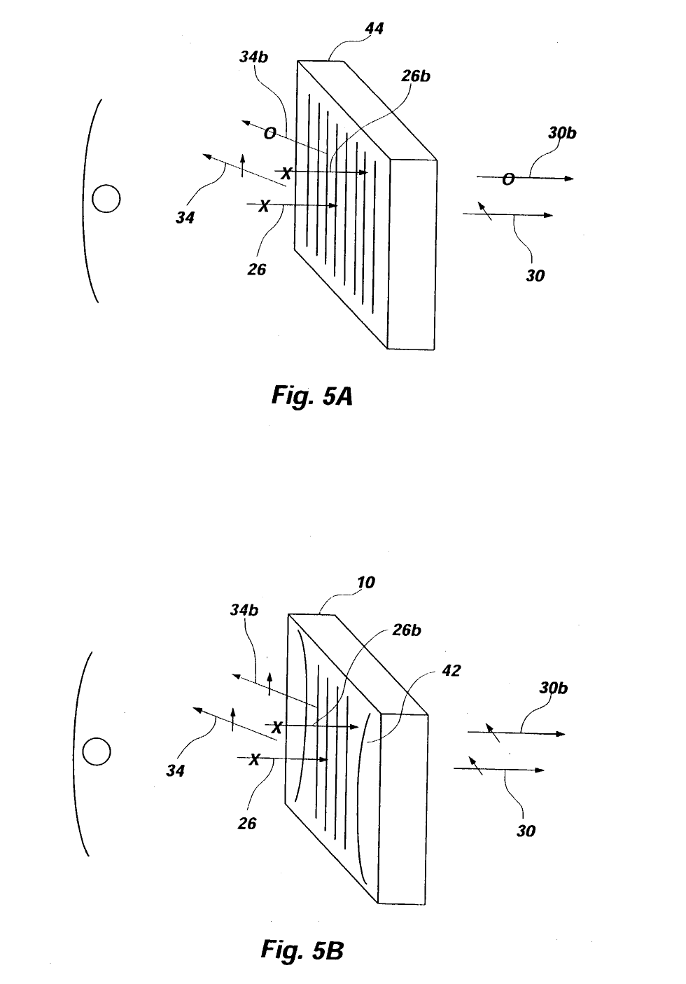

Referring to FIG. 5a, an optical system is shown with a polarizer device 44 which might undesirably affect the beam of light 26. For example, the polarizer device 44 might include a plurality of parallel elements all arranged with a similar orientation. Due to certain properties of the light beam 26 or certain orientation between the light beam 26 and polarizer device 44, however, certain portions of the light beam 26b incident on certain portions of the polarizer device 44, might be treated or affected differently. For example, much of the light beam 26 may be treated uniformly, with the polarizer device 44 transmitting the transmitted beam 30 with one polarization orientation [symbol] , and reflecting the reflected beam 34 with another polarization orientation ↑. Other portions of the light beam 26b, however, may be treated differently, with the polarizer device 44 transmitting a portion 30b with a rotated polarization, indicated by the symbol ∘, and reflecting a portion 34b with a perpendicular polarization ∘. Such different or non-uniform treatment might be undesirable if a uniform transmitted or reflected beam with a uniform polarization orientation was desired.

Referring again to FIG. 1, the polarizer device 10 can be divided into, or conceived as having, four quadrants, designated by I, II, III and IV. The quadrants are defined by a longitudinal axis 46, oriented parallel with, and dividing, at least some of the elements 14, and a lateral axis 50, oriented perpendicular to, and intersecting, the longitudinal axis 46. The quadrants have distal corners 54 opposite an intersection 58 of the axes 46 and 50. The secondary elements 42, or a portion thereof, can be located in the distal corners 54 of the quadrants, so that the secondary elements 42, or portion thereof, in the distal corners 54 have different angular orientation with respect to the other elements.

Referring to FIG. 5b, an optical system is shown with the polarizer device 10 of the present invention. The polarizer device 10 or elements 14 can be configured to substantially transmit visible light of the same first polarization orientation [symbol] , and substantially reflect visible light of the same second polarization orientation [symbol] . For example, the secondary elements 42 can have a different angular orientation, to correct for certain properties of the light beam 26 or certain orientation between the light beam 26 and polarizer device 10, with the resulting transmitted and/or reflected beams 30 and 34 having a more uniform polarization orientation therethrough. A portion 26b of the light beam 26 can be incident on the secondary elements 42, with the different angular orientation, such that the resulting transmitted beam 30b has the same first polarization orientation [symbol] as the rest of the transmitted beam 30. Similarly, the resulting reflected beam 34b can have the same second polarization orientation T as the rest of the reflected beam 34.

The elements 14 can be configured or oriented in numerous ways to achieve the desired results. Referring again to FIGS. 1 and 5b, the secondary elements' 42, or a portion thereof, can extend outwardly away from the longitudinal axis 46, or the primary elements 38. Thus, the secondary elements 42 can be concave, or curve outwardly from the longitudinal axis. In addition, the secondary elements 42, or a portion thereof, can be arcuate, with a simple or complex curvature within a layer defined by the elements 14.

Referring to FIG. 2, another polarizer device 70 is shown which is similar in many respects to the polarizer device described above. The polarizer device 70 includes some elements, or secondary elements 74, which extend inwardly towards the longitudinal axis 46, or primary elements 38. Thus, the secondary elements 74 can be convex, or curving inwardly towards the longitudinal axis.

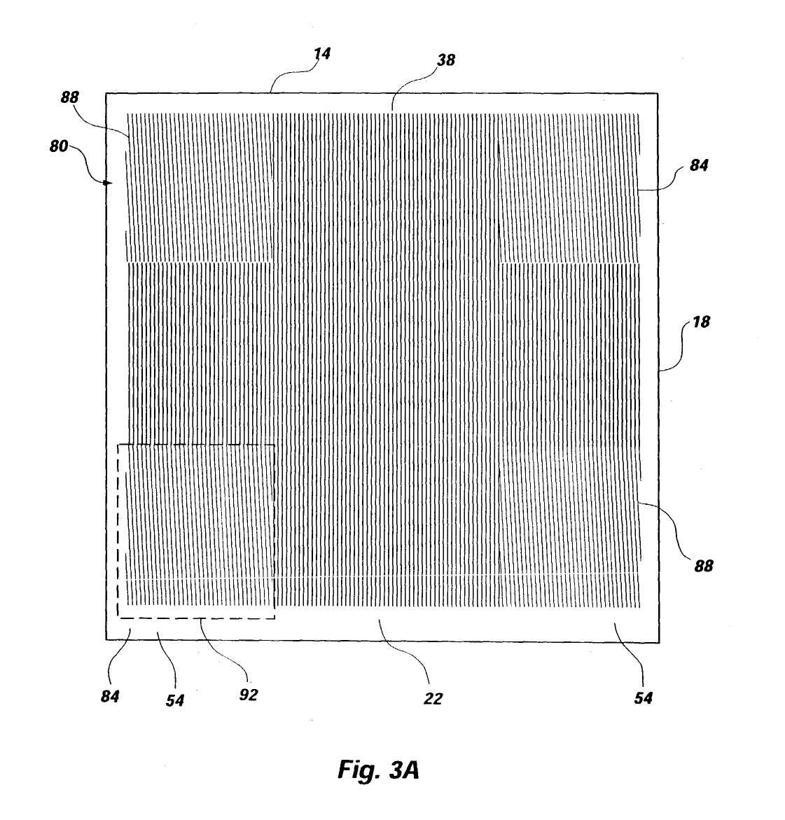

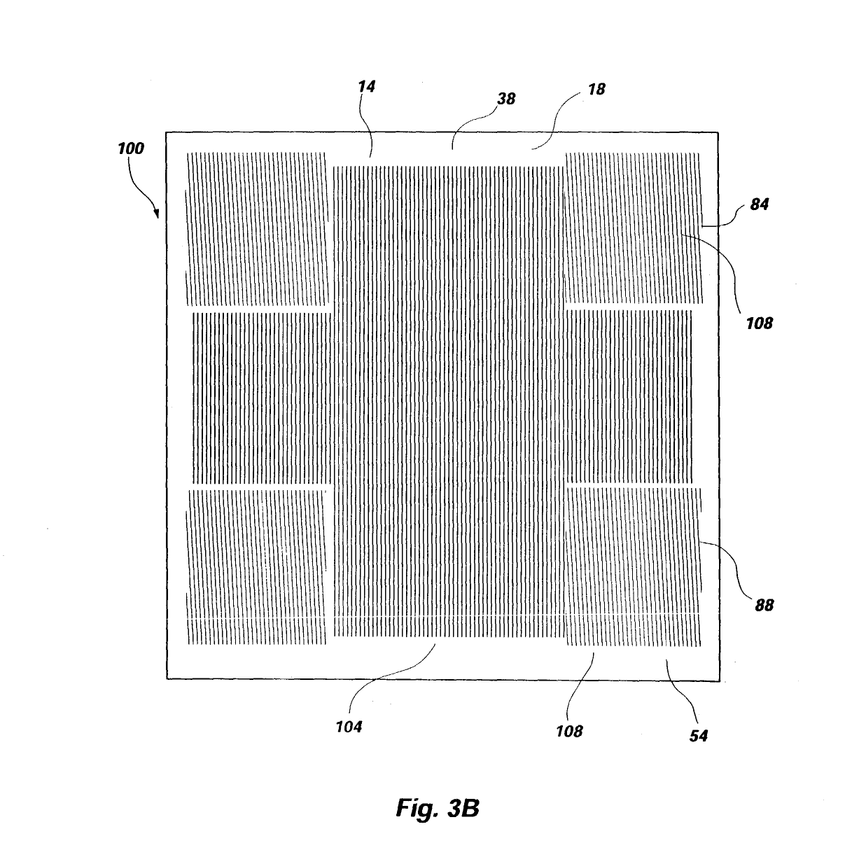

Referring to FIG. 3a, another polarizer device 80 is shown which is similar in many respects to the polarizer devices described above. The polarizer device 80 includes secondary elements 84 and 88 which extend inwardly and outwardly respectively. The secondary elements 84 and 88 are straight, rather than curved. In addition, the polarizer device 80 includes different zones 92, represented by dashed lines. The zones 92 can include primary and secondary zones corresponding to the respective primary and secondary elements 38 and 84 and/or 88. Thus, the zones 92 may be secondary zones including secondary elements 84 and/or 88. The zones 92 treat or affect the light beam differently.

The zones, or primary and secondary elements 38 and 84 and/or 88 can be adjacent or proximal one another to form a continuous polarizer device, as shown in FIG. 3a. In addition, the elements 14, or secondary elements 84 and 88, can be continuous, integral elements with different angular orientations along their lengths. Thus, the secondary elements 84 and/or 88 can extend between zones, with portions of one angular orientation in one zone, and portions of another angular orientation in another zone.

Referring to FIG. 3b, another polarizer device 100 is shown which is similar in many respects to the polarizer device described above. The polarizer device 100 has zones 104 and 108, and primary and secondary elements 38 and 84 and/or 88, which are separate and distinct from one another. Thus, the primary and secondary elements 38 and 84 and/or 88 are disposed at different angular orientations with respect to one another.

Referring to FIGS. 3a and 3b, the zones 92 or 108 having the secondary elements 84 or 88 can be located at the distal corners 54 of the polarizer devices 80 or 100. It is believed that such areas of the polarizer devices are most inclined to undesirably affect the light beam, or transmit or reflect light with an undesired polarization orientation. Locating the secondary elements in other locations, however, is within the scope of the invention.

As stated above, it may be desirable to treat or affect different portions of the light beam 26 differently, or to transmit and/or reflect portions with different polarization orientations. Thus, the polarizer devices described above can have the elements oriented differently to transmit and reflect different polarization orientations, as well as to transmit and reflect the same polarization orientations.

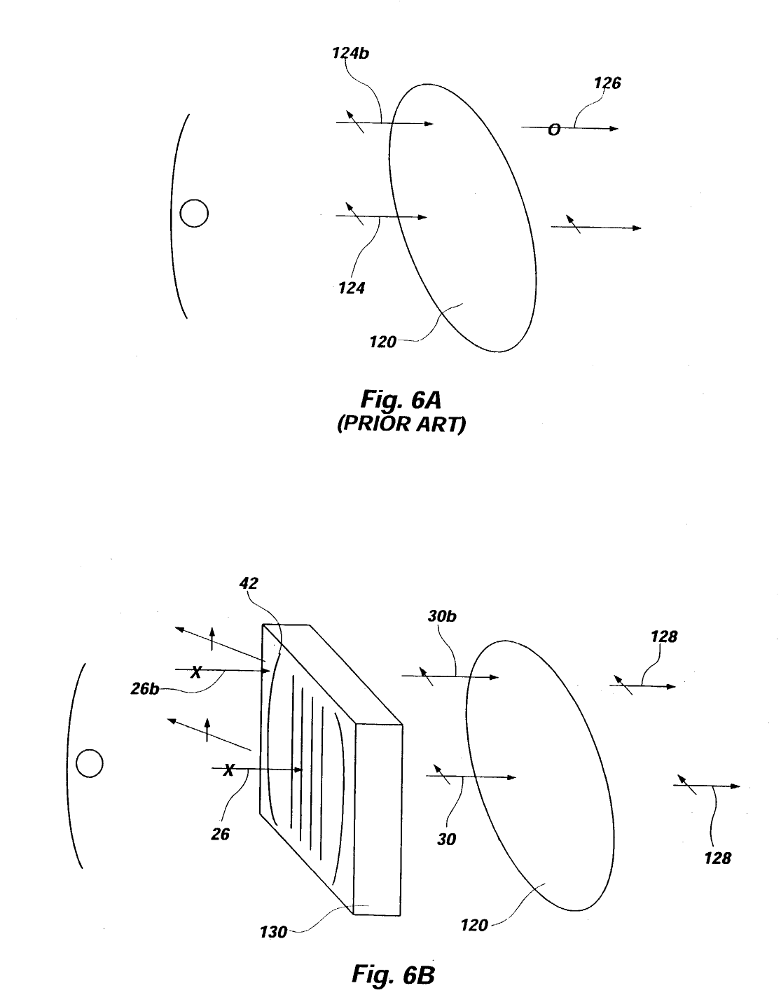

Referring to FIG. 6a, an optical system is shown with an optical element 120 capable of undesirably modifying at least a portion of the light beam. For example, the optical element 120 can be disposed in a polarized light beam 124. Due to certain properties of the light beam 124 or certain orientation between the light beam 124 and optical element 120, however, certain portions of the light beam 124b incident on certain portions of the optical element 120, might be treated or affected differently. For example, much of the light beam 124 may be treated uniformly, with the optical element 120 maintaining the polarization orientation of the light beam 124. Other portions of the light beam 124b, however, may be treated differently, with the optical element 120 undesirably rotating or inducing an elliptical orientation into at least a portion of the light beam 126, indicated by the symbol ∘.

Referring to FIG. 6b, an optical system is shown with the polarizer device 130 of the present invention. The polarizer device 130 or elements 14 can be configured to transmit visible light with different polarization orientations. In addition, some elements, groups of elements or zones can correspond to portions of the optical element 120 which undesirably affect the light beam. For example, the secondary elements 42 can have a different angular orientation, to correct for certain properties of the light beam 26b or certain orientation between the light beam 26 and optical element 120, with the resulting transmitted beams 30 and 30b with different polarization orientations. A portion 26b of the light beam 26 can be incident on the secondary elements 42, with the different angular orientation, such that the resulting transmitted beam 30b has a different polarization orientation from the rest of the transmitted beam 30. The orientation of the secondary elements 42 can be configured to compensate for the optical element 120, such that the resulting beams 128 from the optical element 120 have a more uniform polarization orientation.

As an example, consider designing such a polarizer to be placed immediately ahead of a spherical lens that is not dichromic or birefringent. Such a lens rotates polarized light by the following mechanism. The ray along the axis of the lens is undeviated in its path, and completely maintains it polarization. Other rays will have their paths changed by the action of the lens, causing a rotation of some degree in the polarization orientation of this ray. The electric vector of the other rays will be rotated by the lens. One approach to solving this problem is to use the lines of a wire grid polarizer to select the orientation of the light before it enters the lens so it will have the desired orientation after the lens has rotated it and allowed its exit. Alternatively, the lines of a wire grid polarizer can be used after the light passes through the lens.

In addition, a retarder, as is known in the art, also can be inserted to correct for any elliptical polarization induced by the optical element, by inducing a counter elliptical polarization.

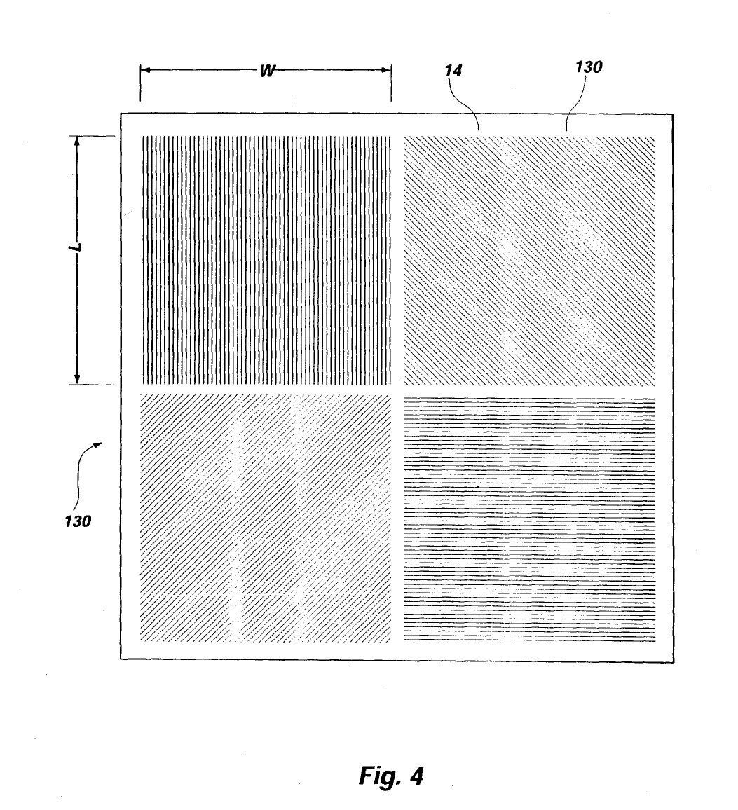

Referring to FIG. 4, a polarizer device 130 is shown which is similar in many respects to the polarizer devices described above. The polarizer device 130 advantageously includes a plurality of adjacent groups 134 of elements 14. The elements within a group have a similar angular orientation with respect to one another. The elements of one group can have a different angular orientation with respect to elements of another group. Thus, the groups 134 can transmit and reflect different polarization orientations. The groups 134, however, can be oriented to transmit and/or reflect the same polarization orientations, as discussed above.

The groups 134 have a length L parallel to the elements 14, and a width w lateral to the elements 14. Preferably, the width w is greater than the wavelength of visible light, or greater than approximately 400 nm (0.4 μm). In addition, the groups 134 preferably are relatively adjacent one another. Adjacent groups 134 preferably are spaced apart less than a width w the groups 134, and/or less than the wavelength of visible light, or approximately 400 nm (0.4 μm). Thus, the polarizer device 130 can process as much of the light beam as possible.

A plurality of pixels may be disposed behind the polarizer device, with each pixel disposed behind one of the groups, as described below.

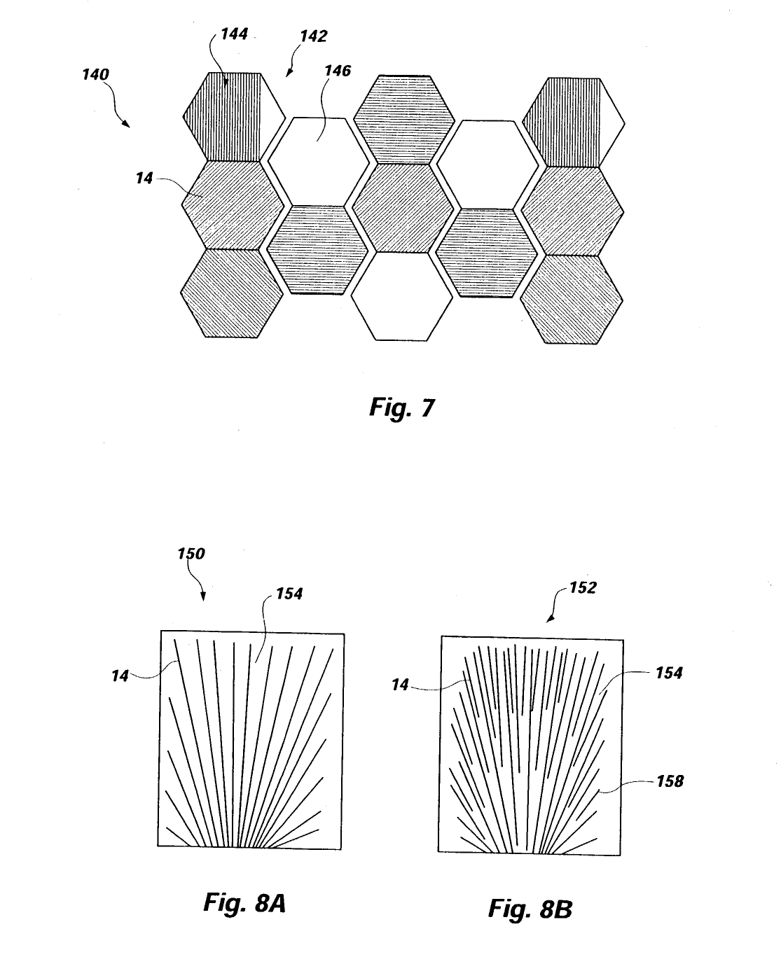

Referring to FIG. 7, a polarizer device 140 is shown which is similar in many respects to the polarizer devices described above. The polarizer device 140 has a plurality of adjacent zones 142. A plurality of adjacent groups 144 of elements 14 are each disposed in one of the zones 142. The elements 14 of one group have a different orientation with respect to elements of another group. Thus, the zones 142 are configured to transmit visible light of different polarization orientations.

The plurality of zones 142 can further include one or more open zones 146 without any elements. Each zone of elements can be configured to correspond to a pixel, such as with a ccd camera. Thus, the pixels can be configured to receive light of different polarizations through the various zones 142 or groups 144, an unaltered light through the open zones 146.

In addition, the zones 142 and groups 144 can be sized and shaped as desired. For example, the zones 142 or groups 144 have a polygon shape with more than three or four sides. The zones 142 or groups 144 can be shaped as hexagons, as shown. It is of course understood that other shapes can be used, such as triangles, squares, octagons, etc., to suit the application, such as corresponding to the pixels, maximizing surface area coverage, and/or facilitating manufacture.

Referring to FIGS. 8a and 8b, other polarizer devices 150 and 152 are similar in many respects to the polarizer devices described above. The elements 14 can form acute angles with respect to one another, with widening gaps 154 therebetween. The elements may extend radially in a fan-like manner. Advantageously, the polarizer device 152 has a plurality of elongated secondary elements 158, each one disposed in one of the widening gaps 154 between the primary elements.

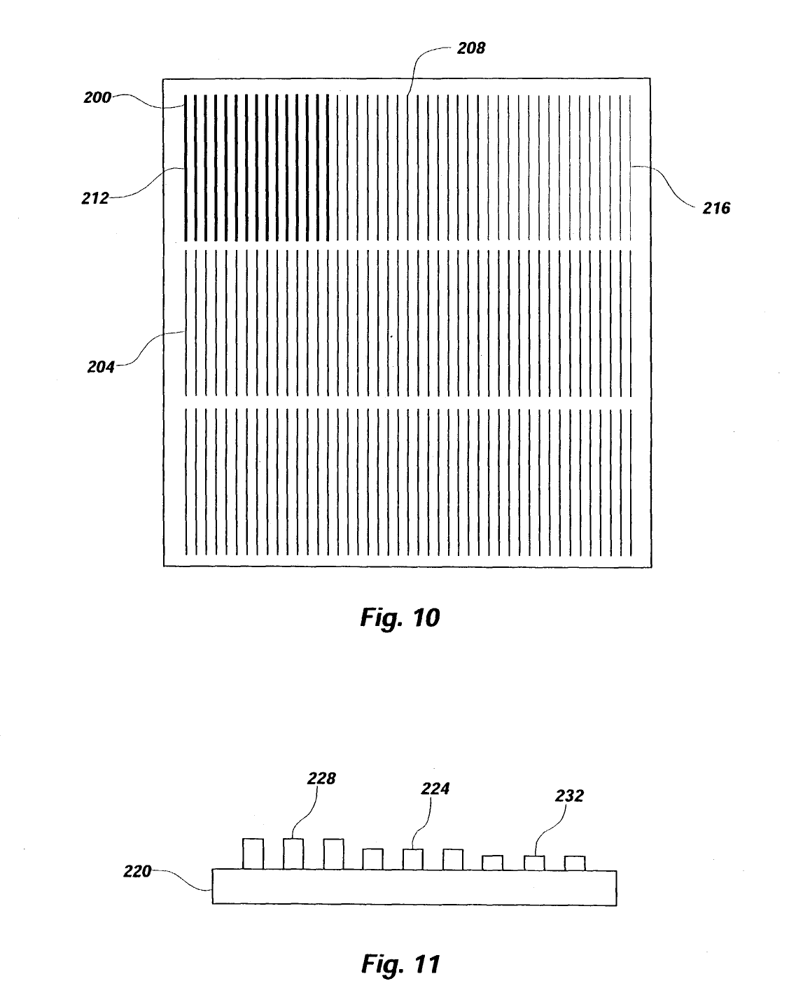

Referring to FIG. 10, another polarizer device, indicated generally at 200, is shown which is similar in many respects to the polarizer devices described above. The polarizer device 200 includes a plurality of elements 204, including primary elements 208, and secondary elements 212 and 216. Another variation in the optical properties of the polarizer can be obtained by variation of the element or wire width. The primary elements 204 can have a first width, as described above. The secondary elements 212 and 216 can have different widths. For example, the secondary elements 212 can be wider, and have narrower gaps therebetween, which can result in better contrast, but less transmission. Alternatively, the secondary elements 216 can be narrower, and have wider gaps therebetween, which can result in better transmission, but less contrast. All of the elements 208, 212 and 216 can have the same period, as shown, or period of the primary and secondary elements can vary. The primary elements 208 can be separate and distinct from the secondary elements 212 and 216. Alternatively, the elements 204 can have a portion with a first width, such as with the primary elements 208, and a portion with a wider or narrower width, such as with secondary elements 212 or 216, respectively. The change in width can be abrupt, or can be smooth from one part of the polarizer to another.

As described above, the polarizer 200 can have groups or zones defined by the width of the elements 204. For example, one group or zone can have primary elements 208 with a first width, while another group or zone can have secondary elements 212 or 216 which are wider or narrower.

In addition, the height and shape of the elements or wires can be changed from one group of elements to another. Referring to FIG. 11, another polarizer device, indicated generally at 220, is shown. The polarizer device 220 has primary elements 224 with a first height or thickness, and secondary elements 228 and 232 with thicker or thinner elements. Changing the height of the elements allows for increased contrast while also affecting the transmission of the polarizer. The shape can be altered by changing the slope angle of the sidewalls of the elements, arriving at a shape that is tetrahedral rather than rectangular. Other alterations of the shape can include rounding the corners, etc. Altering the thickness or height, the width, and the shape of the elements also proved control of the interaction of the transmitted beam of light with the underlying substrate in a manner substantially similar to the behavior of a thin dielectric film. In effect, the elements behave as a dielectric layer with optical properties determined by the characteristics of the elements.

As the period, height or thickness, width or other features are varied to create a patterned polarizer, it will often be advantageous to alter other aspects of the elements, such as those identified above in a controlled manner to optimize the effective dielectric effect of the elements. This would be done, for example, to provide the vest transmission and/or contrast performance. These changes can be implemented in a gradual or smooth manner, or abruptly, as described above for the particular case of the element width.

The polarizer devices described above can be referred to as mosaic or patterned polarizers. Such polarizer devices can have numerous applications.

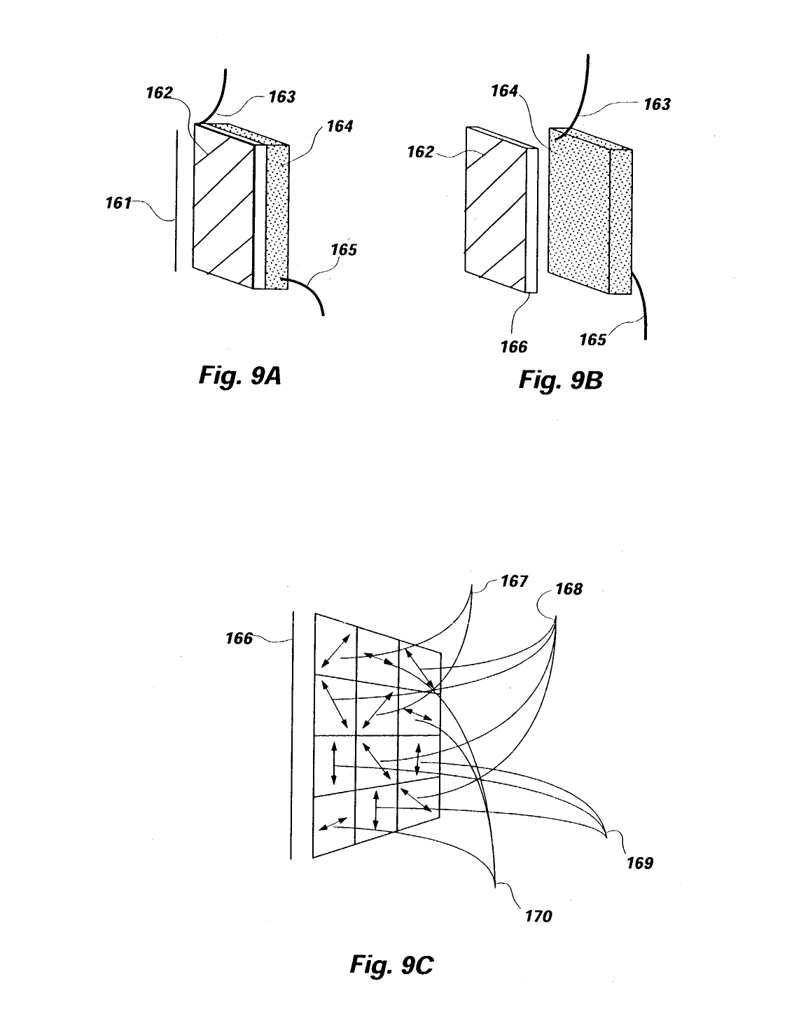

For example, referring to FIG. 9a, a single polarized pixel 161 is diagramed. Polarizing wires 162 are applied directly to a surface of a photodetector to eliminate parallax. They are at a +45° angle in this case. The wires can serve as one of the electrodes for the detector via connector 164. Another connector 165 is also shown connected to the back of the photodetector.

FIG. 9b is an exploded view showing the polarizing wires 162 supported by a thin transparent substrate 166. In operation, the substrate 166 would be close to the phototdetector 165 to limit parallax. Alternatively, the polarizing wires could be placed on the substrate surface that is closest to the photodetector.

Referring to FIG. 9c, a practical application is shown with an array 166 of such pixels. Double pointed arrows show the orientation of polarization that passes each pixel. Four different orientations are shown, but fewer or more orientations can be used for a particular application. The signals from the +45° pixels are collected into a cable 167, and the −45° pixels are collected into another cable 168. Similarly, the signals from the vertical pixels are collected into a cable 169, and those from horizontal pixels go to another cable 170. Thus, when an image is cast on the array 166, four images will be produced in the cables, and each image will have its own polarization.

What is more, the compliment of each image is reflected by the wires so that one or more of these complimentary images can be collected by additional optical imaging and detection equipment. A complimentary image has several uses. The sum of the intensity of an image and its compliment should be a constant that is proportional to the total light intensity. This is true for each pixel as well as for the entire array of pixels of the same orientation. In addition, if an area is dim in the image strictly because of polarization orientation, it will be correspondingly bright in the reflected complement. This access to “extinct” light improves the accuracy of calculating high degrees of polarization.

Such a patterned or mosaic polarizing device for visible light can be used in imaging. Electromagnetic radiation reflected from a dielectric material is partially polarized. A given reflection will appear dim if viewed through a polarizer that blocks the reflected polarization. However, it will appear intense if the polarizer is rotated 90° to pass the reflected polarization. A ccd detector with many pixels can be used to turn the light into an electrical signal that could form an image on a monitor. Each group or zone with one orientation can be placed over a selected set of pixels, and another polarizer orientation placed over another set. Multiple sets with multiple different orientations produce multiple images of the same scene with different polarization orientations. Variation in the polarization of light reflected from the object will result in variations in the intensity reaching each of the multiple polarized pixels viewing a given spot in the subject. From this, angles of parts of the subject relative to the source of illumination can be determined. In addition, if contrast between adjacent objects is low in one polarized image, it is likely to be high in one of the others. What is more, reflection from metal surfaces will obey different rules, and metal reflections can be distinguished from reflection by non-metals. These characteristics are of great value in interpreting the true shape and nature of the object being viewed by the ccd camera. An especially dramatic example is the spots of glare coming from the waves on a lake or ocean. For each polarization orientation, the spots indicate all of the positions where the water has a specific inclination with respect to the sun and the point of viewing.

Another example of patterned polarizer use occurs in the industrial inspection of manufactured items. In one case, light reflected from items as they pass on a conveyor belt is detected and used to verify the presence of the item. Certain characteristics of the item can also be measured. Background light severely hinders this process, so the illumination is polarized and the detector responds only to this polarization. With a mosaic polarizer, one can not only detect the item in spite of background, but can verify the expected dielectric and metallic reflections from the various facets of the item.

Yet another example of a use for a mosaic polarizer array occurs where the stress that is present in an object chances the polarization of transmitted for reflected light. Observation of the spatial distribution of polarization provides important information about stress and potential failure of the part. The mosaic polarizer allows one to measure the extent of polarization change simultaneously at many points on the object, either in monochromatic or white light.

A mosaic polarizer array would also simplify certain types of polarimeters where the incoming light needs to be measured in terms of its ellipticity and the orientation of the major axis. A mosaic of linear polarizers, some with properly adjusted wave plates, could transmit the proper intensities to detectors and allow the immediate calculation of the ellipticity and orientation of the incoming light.

These are but a few examples of many which illustrate the usefulness of patterned polarizers, especially if they operate well in the visible spectrum and if they can be made small for use with the pixels of an image.

Unfortunately, it is difficult and time consuming to make a polarizer mosaic of a practical size unless the mosaic has only a few large areas with different orientations of polarization. Most applications require a complex polarizing mosaic. It would be useful, in general, to be able to manufacture any set of relative orientations for the polarizer pixels, select their sizes and shapes, and cover the entire area seamlessly. Specifically, the areas must not be mis-oriented; they must not overlap at junctions; and they must not leave gaps between areas that will allow unpolarized light to degrade the image. In some applications, the polarizer must be thin and close to the detector or parallax of the incident light will cause crosstalk between adjacent pixels. In other applications, the mosaic itself is imaged on a distant target, so the polarizer can be thicker. For some applications, the polarizer must work well for a wide variety of angles of incidence, i.e. it must have a wide acceptance angle.

As described above, although there are a number of different types of polarizers, not all can be made in complex patterns with many small areas that are thin and that have wide acceptance angles.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A visible light polarizer device, comprising:
a) a plurality of elongated elements sized to interact with visible light to substantially transmit visible light of one polarization orientation, and substantially reflect visible light of another polarization orientation; and
b) at least a portion of at least one of the elements having a different angular orientation with respect to other elements.

2. A device in accordance with claim 1, wherein the plurality of elements includes primary elements which are substantially parallel with one another, and secondary elements having at least a portion disposed at a different angular orientation with respect to the primary elements.

3. A device in accordance with claim 1, wherein all of the elements are configured to substantially transmit visible light of a common first polarization orientation, and substantially reflect visible light of a common second polarization orientation.

4. A device in accordance with claim 1, further comprising:
four quadrants defined by a longitudinal axis parallel with and dividing at least some of the elements, and a lateral axis perpendicular to and intersecting the longitudinal axis, the quadrants having distal corners opposite an intersection of the axes; and
wherein at least one of the elements located in the distal corners of the quadrants have at least a portion disposed at a different angular orientation with respect to the other elements.

5. A device in accordance with claim 4, wherein the portion of the elements in the distal corners extend inwardly towards the longitudinal axis.

6. A device in accordance with claim 4, wherein the portions of the elements in the distal corners extend outwardly away from the longitudinal axis.

7. A device in accordance with claim 1, wherein at least a portion of at least one of the elements is arcuate, and has a curvature within a layer defined by the elements.

8. A device in accordance with claim 1, wherein some of the elements are concave with respect to a longitudinal axis parallel with and dividing at least some of the elements.

9. A device in accordance with claim 1, wherein some of the elements are convex with respect to a longitudinal axis parallel with and dividing at least some of the elements.

10. A device in accordance with claim 1, wherein the plurality of elements includes:
a) a plurality of adjacent groups of elements;
b) the elements within a group having similar angular orientations; and
c) the elements of at least one group having a different angular orientation with respect to elements of at least one other group.

11. A device in accordance with claim 10, wherein the groups are configured to transmit visible light of different polarization orientations.

12. A device in accordance with claim 10, wherein all of the groups are configured to transmit visible light of substantially the same polarization orientation.

13. A device in accordance with claim 10, wherein the groups have a length oriented parallel to the elements, and a width oriented lateral to the elements, the length and width being greater than a wavelength of visible light.

14. A device in accordance with claim 10, wherein adjacent groups are spaced apart a distance less than a width of one of the adjacent groups.

15. A device in accordance with claim 10, wherein adjacent groups are spaced apart a distance less than a wavelength of visible light.

16. A device in accordance with claim 10, wherein the groups have a polygon shape with more than three sides.

17. A device in accordance with claim 10, further comprising at least one open zone, sized substantially the same as one of the groups, without any elements.

18. A device in accordance with claim 10, further comprising:
a plurality of photodetectors, each one disposed behind one of the groups.

19. A device in accordance with claim 1, wherein the elements have a period less than 200 nm.

20. A device in accordance with claim 1, wherein the elements have a width, and wherein at least one of the elements has a width different than the widths of other elements.

21. A device in accordance with claim 1, wherein the elements have a thickness, and wherein at least one of the elements has a thickness different than the thicknesses of other elements.

22. A polarizer device, comprising:
a) a transparent substrate having a first surface; and
b) a plurality of elongated primary and secondary elements, disposed on the first surface of the substrate, sized to interact with visible light to substantially transmit visible light of a first polarization orientation, and substantially reflect visible light of a second polarization orientation; and
c) the primary and secondary elements having a different angular orientation with respect to one another.

23. A device in accordance with claim 22, wherein the primary and secondary elements are both configured to substantially transmit visible light of a common first polarization orientation, and substantially reflect visible light of a common second polarization orientation.

24. A device in accordance with claim 22, further comprising:
four quadrants defined by a longitudinal axis parallel with and dividing the primary elements, and a lateral axis perpendicular to and intersecting the primary elements, the quadrants having distal corners opposite an intersection of the axes; and
wherein the secondary elements each have a portion, located in one of the distal corners of one of the quadrants, disposed at a different angular orientation with respect to the primary elements.

25. A device in accordance with claim 24, wherein the portion extends inwardly towards the primary elements.

26. A device in accordance with claim 24, wherein the portion extends outwardly away from the primary elements.

27. A device in accordance with claim 22, wherein at least a portion of the secondary elements is arcuate, and has a curvature within a layer defined by the elements.

28. A device in accordance with claim 22, wherein the secondary elements are concave with respect to a longitudinal axis parallel with and dividing at least some of the elements.

29. A device in accordance with claim 22, wherein the secondary elements are convex with respect to a longitudinal axis parallel with and dividing at least some of the elements.

30. A device in accordance with claim 22, wherein the plurality of elements includes:
a) a plurality of adjacent groups of elements;
b) the elements within a group having similar angular orientations; and
c) the elements of at least one group having a different angular orientation with respect to elements of at least one other group.

31. A device in accordance with claim 30, wherein the groups are configured to transmit visible light of different polarization orientations.

32. A device in accordance with claim 30, wherein the groups are configured to transmit visible light of substantially the same polarization orientation.

33. A device in accordance with claim 30, wherein the groups have a length oriented parallel to the elements, and a width oriented lateral to the elements, the length and width being greater than a wavelength of visible light.

34. A device in accordance with claim 30, wherein adjacent groups are spaced apart a distance less than a width of one of the adjacent groups.

35. A device in accordance with claim 30, wherein adjacent groups are spaced apart a distance less than a wavelength of visible light.

36. A device in accordance with claim 30, wherein the groups have a polygon shape with more than three sides.

37. A device in accordance with claim 30, further comprising at least one open zone, sized substantially the same as the groups, without any elements.

38. A device in accordance with claim 30, further comprising:
a plurality of photodetectors, each one disposed behind one of the groups.

39. A device in accordance with claim 22, wherein the elements have a period less than 200 nm.

40. A device in accordance with claim 22, wherein the primary and secondary elements have different widths with respect to one another.

41. A device in accordance with claim 22, wherein the primary and secondary elements have different thicknesses with respect to one another.

42. A polarizer device, comprising:
a) a transparent substrate having a first surface;
b) a plurality of adjacent zones on the first surface of the substrate representing discrete surface areas; and
c) a plurality of adjacent groups of elongated, parallel elements, each group disposed in one of the zones on the first surface of the substrate, sized to interact with visible light to substantially transmit visible light of one polarization orientation, and substantially reflect visible light of another polarization orientation; and
d) the elements of one group having a different orientation with respect to elements of another group.

43. A device in accordance with claim 42, wherein the groups have a length oriented parallel to the elements, and a width oriented lateral to the elements, the length and width being greater than a wavelength of visible light.

44. A device in accordance with claim 42, wherein adjacent groups are spaced apart a distance less than a width of one of the adjacent groups.

45. A device in accordance with claim 42, wherein adjacent groups are spaced apart a distance less than a wavelength of visible light.

46. A device in accordance with claim 42, wherein the groups have a polygon shape with more than three sides.

47. A device in accordance with claim 42, wherein the elements have a period less than 200 nm.

48. A device in accordance with claim 42, wherein at least some of the elements are arcuate and have a curvature within the first surface.

49. A device in accordance with claim 42, wherein the plurality of zones further includes at least one open zone without any elements.

50. A device in accordance with claim 42, further comprising:
a plurality of photodetectors, each one disposed behind one of the zones.

51. A device in accordance with claim 42, wherein the elements of one group have a different width with respect to elements of another group.

52. A device in accordance with claim 42, wherein the elements of one group have a different thickness with respect to elements of another group.

53. A polarizer device, comprising:
a) a plurality of elongated elements disposed in a layer and sized to interact with visible light to substantially transmit visible light of one polarization orientation, and substantially reflect visible light of another polarization orientation; and
b) the elements being arcuate and have a curvature within the layer.

54. A device in accordance with claim 53, wherein the elements have a period less than 200 nm.

55. A device in accordance with claim 53, further comprising:
a plurality of adjacent groups of elements.

56. A polarizer device, comprising:
a) a plurality of elongated primary elements sized to interact with visible light to substantially transmit visible light of one polarization orientation, and substantially reflect visible light of another polarization orientation;
b) the elements forming acute angles with respect to one another and widening gaps therebetween; and
c) a plurality of elongated secondary elements, each one disposed in one of the widening gaps between the primary elements.

57. A device in accordance with claim 56, wherein the elements have a period less than 200 nm.

58. A method for treating a visible beam of light to compensate for an undesired optical effect applied by an optical element, the method comprising the steps of:
a) passing the beam of light through an optical element capable of undesirably modifying at least a portion of the beam of light;
b) passing a portion of the beam of light through a first group of elongated elements; and
c) passing a portion of the beam of light through a second group of elongated elements having a different orientation with respect to the elements of the first group, to compensate for the undesirable modification by the optical element.

59. A method in accordance with claim 58, wherein the steps of passing the portions of the beam of light through the first and second groups of elongated elements further includes:
passing the portions of the beam of light through the first and second groups of elongated elements prior to passing the beam of light through the optical element.

60. A method in accordance with claim 58, wherein the step of passing the beam of light through the optical element further includes:
passing the beam of light through an optical element which is capable of undesirably rotating the polarization orientation of at least a portion of the beam of light; and
wherein the steps of passing at least a portion of the beam of light through the first and second groups of elements further includes:
passing the at least a portion of the beam of light through first and second groups of elements prior to passing the beam of light through the optical element to transmit a polarization orientation of at least a portion of the beam of light prior to exposure to the optical element.

61. A method in accordance with claim 58, wherein the steps of passing at least a portion of the beam of light through the first and second groups of elements further includes:
passing at least a portion of the beam of light through a group of curved elements.

62. A method in accordance with claim 58, further including the step of:
passing at least a portion of the beam of light through a retarder to induce an elliptical polarization into the at least a portion of the beam of light.

63. A method in accordance with claim 58, wherein the steps of passing at least a portion of the beam of light through the first and second groups of elements further includes:
passing the at least a portion of the beam of light through a polarizer with elements configured to correct the undesirable optical effect.
